(19) United States
(12) Patent Application Publication
(10) Pub. No.: US 2013/0199318 A1
(43) Pub. Date: Aug. 8, 2013

(54) ACTUATOR ASSEMBLY

(71) Applicant: Ki Seong Lee, Suwon-si (KR)

(72) Inventor: Ki Seong Lee, Suwon-si (KR)

(73) Assignee: Kyungdong Navien Co., Ltd., Pyeongtaek-si, Gyeonggi (KR)

(21) Appl. No.: 13/820,135

(22) PCT Filed: Mar. 20, 2011
(86) PCT No.: PCT/KR2011/001908

§ 371 Date: Mar. 21, 2013

(30) Foreign Application Priority Data
Sep. 3, 2010 (KR) 10-2010-0086254

(51) Int. Cl. F16H 25/14

(52) U.S. Cl. CPC F16H 25/14
USPC 74/54

(57) ABSTRACT

The present invention relates to an actuator assembly, and provides an actuator assembly comprising: an upper case; a lower case; an actuator interposed between the upper and the lower cases; a cam coupled to the actuator; and a shutter connected to the cam, in which the cam includes protrusions and recesses, which are alternately formed at an interval of 90°, a hook is provided of which one end is disposed so as to alternately come into contact with the protrusions and the recesses according to a rotation of the cam, the other end is coupled to a spring, a longitudinal middle protrudes so as to form a touch part, and a hook shaft is coupled to a portion between the touch part and the other end of the hook, and a single microswitch is further provided at an upper side of the cam in order to stop an operation of the actuator in accordance with contact with the touch part.

According to the present invention, the actuator assembly has a simple structure, and may be accurately controlled, and may achieve excellent sealing performance and improvement in durability, and because the actuator assembly may be controlled using the single microswitch, a reduction in cost and in fraction defective may be achieved.

### TECHNICAL FIELD

The present invention relates to an actuator assembly, and more particularly, to an actuator assembly which is improved to be easily controlled and to have a simple structure and excellent durability by using an AC synchronous motor as an actuator of an electric damper used in a product relevant to ventilation such as a ventilation apparatus, a kitchen hood, or a bathroom fan.

### BACKGROUND ART

In general, in a ventilation apparatus including an air conditioning system of a building, a kitchen hood, and a bathroom fan, an electric damper is installed at a duct in order to supply an accurate amount of air necessary for ventilating a room.

In the electric damper, a sealing state needs to be maintained when the damper is cut off, and the electric damper needs to be adjusted by a proportional control of a driving motor when the damper is opened.

Such electric damper has been typically used by mounting a B.D.D (back draft damper) but this has a problem in sealing performance because of the structure which is operated by a self weight, and therefore a M.D (motorized damper) type electric damper is mainly used at present.

The electric damper is classified into an AC type and a DC type in accordance with an electric power input type of a driving unit, that is, an actuator for operating the electric damper and is classified into an ON-OFF type and an automatic reset type in accordance with a driving type.

For example, FIG. 1 illustrates an example of an electric damper of the prior art, and as illustrated, a shutter 2 having a circular plate shape is installed in an exhaust port frame 1 to be rotatable by a shaft 3, and a gear and a motor 4 are installed on a rotating axis of the shaft 3, such that a flow path of the exhaust port frame 1 is opened and closed while the shutter 2 is rotated by an operation of the motor 4.

Further, a soft elastic gasket 7 having a recess 5 and an elastic portion 6 is coupled to an edge surface of the shutter 2 to maintain a sealing state.

Here, the exhaust port frame 1 is merely an example, and may be various objects such as an air nozzle or the like.

In recent years, as an example of other electric dampers having a simple and easily controlled structure, as illustrated in FIG. 2, a cam 8 and two microswitches 9 tend to be used to limit a rotation angle of the shutter 2 to a predetermined angle range by receiving power from the motor 4.

However, when a DC motor (DC type) is used as the motor 4, the DC type has an advantage over an AC type in that manipulation is simple and high torque may be obtained, but because the DC type needs to be equipped with a converter which converts an AC input voltage into a DC voltage, the cost is increased, and in the case of the automatic reset type, because the automatic reset type determines an OFF state by using spring tension, when the automatic reset type is used for a long period of time, a problem occurs due to a change in elasticity of the spring.

To improve the above problem, an AC synchronous motor may be used as the motor 4, and in this case, in a damper, that is, a mechanical configuration of a driving unit to turn on and off the shutter 2 by 90°, an unreasonable load may be applied to electronic products such as a microswitch 9. Also, the open and close operations of the shutter 2 may not be accurately performed because its ON/OFF accuracy deteriorates due to the pressed microswitch 9, and the above problems cause other problems such as an increase in load of a blower and deterioration in sealing performance.

### DISCLOSURE

### Technical Problem

The present invention has been made in an effort to efficiently solve the aforementioned problems of the prior art, and the object of the present invention is to provide an actuator assembly having a simple structure, capable of preventing occurrence of an unreasonable load at the time of driving an actuator, when an AC synchronous motor is used for an actuator used in an apparatus which includes an electric damper and requires an actuating operation; accurately controlling open and close operations of a shutter by using a cam, a hook, and a spring; and improving durability.

### Technical Solution

To achieve the above object, the present invention provides an actuator assembly comprising: an upper case; a lower case; an actuator interposed between the upper and lower cases; a cam coupled to the actuator; and a shutter connected to the cam, in which the cam includes protrusions and recesses, which are alternately formed at an interval of 90°; a hook is provided of which one end is disposed so as to alternately come into contact with the protrusions and the recesses according to a rotation of the cam, the other end is coupled to a spring, a longitudinal middle protrudes so as to form a touch part, and a hook shaft is coupled to a portion between the touch part and the other end of the hook; and a single microswitch is further provided at an upper side of the cam in order to stop an operation of the actuator in accordance with contact with the touch part.

Here, the actuator may be an AC synchronous motor.

In addition, the actuator and the cam may be rotated in only one direction.

### Advantageous Effects

According to the present invention, the actuator assembly has a simple structure, and may be accurately controlled, and may achieve excellent sealing performance and improvement in durability, and because the actuator assembly may be controlled using the single microswitch, a reduction in cost and in fraction defective may be achieved.

### DESCRIPTION OF DRAWINGS

FIGS. 1 and 2 are exemplary views of an electric damper according to the prior art.

FIG. 3 is an exemplary perspective view of an actuator assembly used in an electric damper according to the present invention.

FIGS. 4 and 5 are exemplary views illustrating an example of an operation of an actuator assembly according to the present invention.

FIG. 6 a circuit diagram for explaining an operation of an actuator according to the present invention.

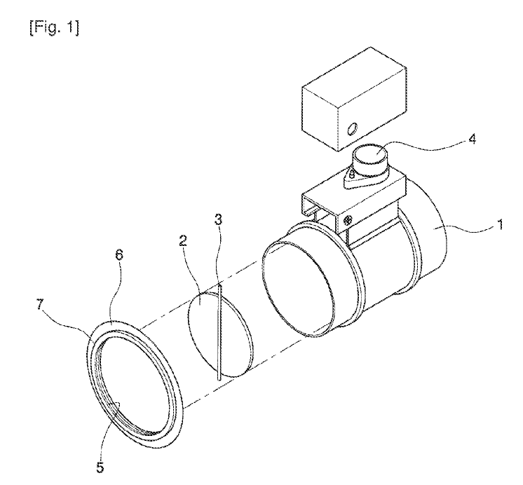

### BEST MODE

Hereinafter, an exemplary embodiment according to the present invention will be described in more detail with reference to the accompanied drawings.

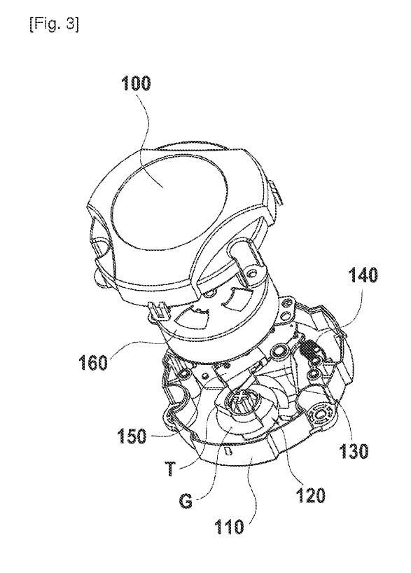

As illustrated in FIGS. 3 to 5, an actuator assembly according to the present invention has a simple structure using a single cam, a single microswitch, and a spring.

Here, as a preferred embodiment of the actuator assembly according to the present invention, an actuator assembly which is used in an electric damper of a ventilation apparatus will be described, but the present invention is not necessarily limited thereto, and of course, the actuator assembly may be applicable to the other apparatuses or products which require an actuating operation.

More specifically, the actuator assembly according to the present invention includes a case that is as a general configuration, and the case is divided into an upper case 100 and a lower case 110 that are able to be assembled.

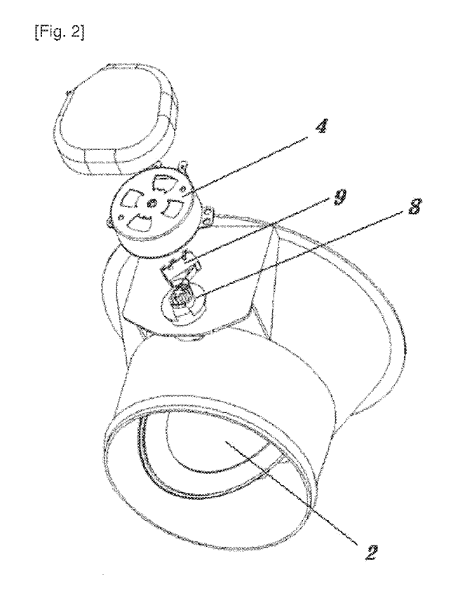

Further, a cam 120 is formed at one side of the lower case 110, and the cam 120 is connected to a rotating shaft, which is not illustrated, of a shutter 2 (see FIG. 2) and is configured to open and close the shutter 2 in accordance with a rotation direction of the cam 120.

In this case, the cam 120 includes protrusions T and recesses G, which are alternately formed at an interval of 90°, and serves to control an operation of an actuator 160, which will be described below.

Here, the illustrated exemplary embodiment describes that the angle of the cam 120 is limited to 90°, but the present invention is not limited thereto, and the angle of the cam 120 may be changed to various angles such as 60°, 45°, or the like that is required for an apparatus or a product.

Moreover, a hook 130, which operates in accordance with a rotation direction of the cam 120, is installed at one side in a radial direction of the cam 120 to be rotatable about a hook shaft 132, and in this case, one end of the hook 130 is in contact with the cam 120, and the other end of the hook 130 is coupled to a spring 140.

Here, one end of the hook 130, which is in contact with the cam 120, has an appearing and disappearing movement while alternately coming into contact with the protrusions T and the recesses G in accordance with a rotation of the cam 120, and accordingly the hook 130 may be rotated about the hook shaft 132.

In addition, the hook 130 is processed so as to be rounded in a longitudinal direction along a shape of the cam 120, a touch part 134 protrudes at the middle of its longitudinal length, and the hook shaft 132 is disposed between the touch part 134 and the other end of the hook 130 coupled to the spring 140.

Meanwhile, a single microswitch 150 is installed inside the lower case 110, which is placed within a radius of movement of the touch part 134, in order to reduce a load.

The microswitch 150 is a type of a limit switch and is provided to stop an operation of an actuator 160, which will be described below, includes a switch lever 152 formed of an elastic member and a switch button 154 switched by pushing and releasing the switch lever 152 as illustrated, and is configured so that a selective terminal connection between a common terminal (COM), a first terminal (NC), and a second terminal (NO) is turned off in accordance with an operation of the switch button 154.

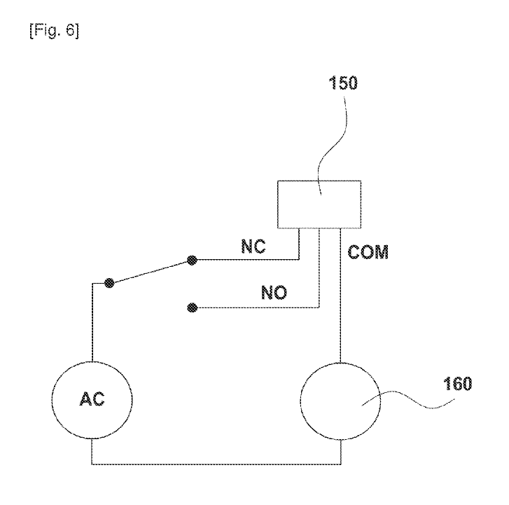

A circuit diagram for implementing the above operation of the microswitch 150 is illustrated in FIG. 6.

Further, an actuator 160 is installed at a center of the cam 120.

The actuator 160 uses an AC synchronous motor to control the connection between the common terminal (COM) and the first and second terminals (NC and NO) by rotating the cam 120 in a predetermined direction.

Here, when an electric voltage is applied by allowing current to flow between the common terminal (COM) and the first terminal (NC), a closed state in which the shutter 2 is closed may be maintained, and when an electric voltage is applied by allowing current to flow between the common terminal (COM) and the second terminal (NO), an opened state in which the shutter 2 is opened may be maintained.

To this end, the cam 120 is formed to have an illustrated structure and is operated to change a state of electric power supply at an interval of 90°.

That is, the actuator 160 is designed to be stopped after being rotated at an interval of 90°.

The present invention having the above structure has an operational relationship as described below.

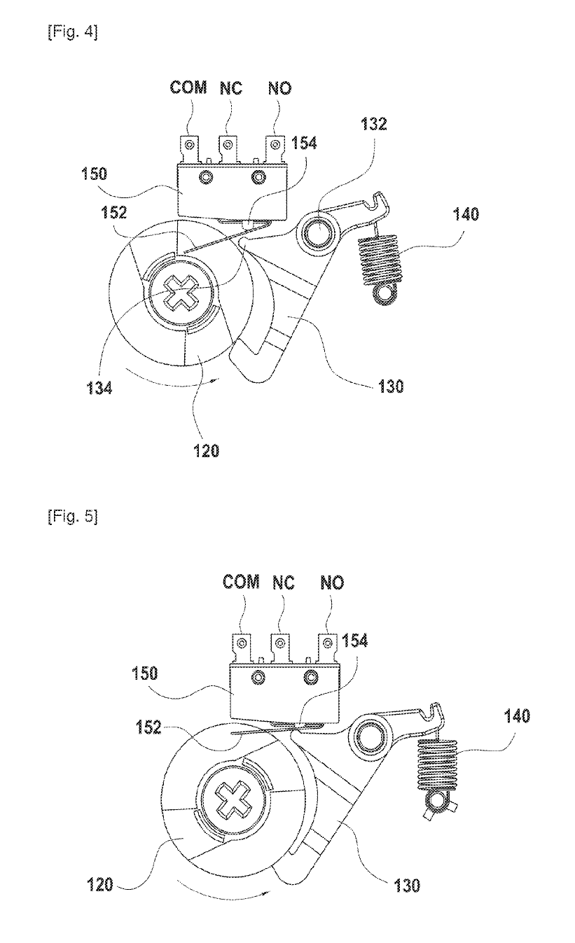

First, when the shutter 2 is opened and electric power is applied to the common terminal (COM) and the terminal (NC) in a state as illustrated in FIG. 4, the actuator 160 is operated by applying the applied electric power to the actuator 160 as illustrated in the circuit diagram of FIG. 6, and accordingly, the shutter 2 is closed as the connected cam 120 rotates in a counter-clockwise direction.

During the above process, when the cam 120 rotates by 90°, an end of the hook 130 which has been in contact with an outer surface of the cam 120, that is, a contact end, is inserted into a lower portion of the cam 120, that is, a cut off portion, and therefore a tense state is relaxed.

At this time, the spring 140 pulls the other end of the hook 130.

Therefore, the hook 130 rotates about the hook shaft 132 in a clockwise direction, the touch part 134 of the hook 130 pushes the switch lever 152 during the above clockwise rotation, and the switch lever 152 presses the switch button 154 so as to cut off the connection between the common terminal (COM) and the first terminal (NC), to thereby stop the actuator 160.

In contrast, when the shutter 2 is opened, if electric power is applied to the common terminal (COM) and the second terminal (NO) in a state as illustrated in FIG. 5, the actuator 160 is operated by applying the applied electric power to the actuator 160 as illustrated in the circuit diagram of FIG. 6, and therefore the connected cam 120 rotates in a counter clockwise direction and opens the shutter 2

At this time, when the cam 120 rotates 90°, the cam 120 pushes up the contact end of the hook 130 to cut off the contact between the touch part 134 and the switch lever 152, thereby stopping an operation of the actuator 160 by operating the microswitch 150.

As such, in the present invention, the cam 120 repeatedly rotates and stops at an interval of 90° to repeatedly control the open and close operations of the shutter 2.

Accordingly, sealing performance is improved since an accurate angle control is possible when open and close operations are performed; electric power consumption of a blower may be reduced because the flow directions are precisely identical in the shutter's opened state; durability may be improved because of a simple structure; and reduction in cost may be achieved by reducing the number of microswitch by one.

### REFERENCE NUMBERS LIST

100: Upper case

110: Lower case

120: Cam

130: Hook

140: Spring

150: Microswitch

160: Actuator

1. An actuator assembly comprising:
an upper case 100;
a lower case 110;
an actuator 160 interposed between the upper case 100 and the lower case 110;
a cam 120 coupled to the actuator 160; and
a shutter 2 connected to the cam 120,
wherein:
the cam 120 includes protrusions T and recesses G which are alternately formed at a predetermined angle;
a hook 130 is provided of which one end is disposed so as to alternately come into contact with the protrusions T and the recesses G according to a rotation of the cam 120, an other end is coupled to a spring 140, a longitudinal middle of the hook 130 protrudes so as to form a touch part 134, and a hook shaft 132 is coupled to a portion between the touch part 134 and the other end; and
a single microswitch 150 is provided at an upper side of the cam 120 in order to stop an operation of the actuator 160 in accordance with contact with the touch part 134.

2. The actuator assembly of claim 1, wherein the actuator 160 is an AC synchronous motor.

3. The actuator assembly of claim 1, wherein the actuator 160 and the cam 120 are rotated in only one direction.
